(19) United States
(12) Patent Application Publication
(10) Pub. No.: US 2026/0290734 A1
(43) Pub. Date: Sep. 24, 2026

(54) ELECTRONIC COMPONENT UNIT AND WIRE HARNESS

(71) Applicant: Yazaki Corporation, Tokyo (JP)

(72) Inventors: Masaaki IWABE, Shizuoka (JP); Noriyuki MAKI, Shizuoka (JP)

(73) Assignee: Yazaki Corporation, Tokyo (JP)

(21) Appl. No.: 19/556,168

(22) Filed: Mar. 4, 2026

(30) Foreign Application Priority Data
Mar. 19, 2025 (JP) 2025-044433

(51) Int. Cl. H01H 85/20

(52) U.S. Cl. CPC H01H 85/2045; H01H 2085/208

(57) ABSTRACT

An electronic component unit includes: a housing that is provided with a housing space that opens on one end side in an assembly direction and into which a tip of a wire is drawn; a fuse that is housed in the housing space with the wire, and disposed on the one end side in the assembly direction of the wire in a state where the fuse intersects the wire; and a cover that has a cover body covering the housing space, and a rib projecting from the cover body toward the other end side in the assembly direction and pressing the wire to a bottom side of the housing space to prevent an interference between the wire and the fuse.

### CROSS-REFERENCE TO RELATED APPLICATION(S)

The present application claims priority to and incorporates by reference the entire contents of Japanese Patent Application No. 2025-044433 filed in Japan on Mar. 19, 2025.

### BACKGROUND OF THE INVENTION

### 1. Field of the Invention

The present invention relates to an electronic component unit and a wire harness.

### 2. Description of the Related Art

As an example of conventional techniques related to electronic component units and wire harnesses, a connector is disclosed that includes a housing, a wire led out from a wire leading-out surface of the housing, a fuse attached to the housing, and a spare fuse attached to the housing, in Japanese Patent Application Laid-open No. JP 2000-091 015 A.

The connector described in Japanese Patent Application Laid-open No. JP 2000-091 015 A, in which the wire and the spare fuse are arranged in contact with each other in a wire guiding space of the housing, has room for further improvement in terms of proper routing of the wire and the fuse.

### SUMMARY OF THE INVENTION

The present invention is made in view of the above circumstance, and aims to provide an electronic component unit and a wire harness that can properly route wires and fuses in a housing space of a housing.

In order to achieve the above mentioned object, an electronic component unit according to one aspect of the present invention includes a housing that is provided with a housing space that opens on one end side in an assembly direction and into which a tip of a wire is drawn; a fuse that is housed in the housing space with the wire, and disposed on the one end side in the assembly direction of the wire in a state where the fuse intersects the wire; and a cover that has a cover body covering the housing space from the one end side in the assembly direction, and a rib projecting from the cover body toward the other end side in the assembly direction and pressing the wire to a bottom side of the housing space to prevent an interference between the wire and the fuse.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire harness to which an electronic component unit according to an embodiment is applied;

FIG. 2 is an exemplary exploded perspective view of the electronic component unit according to the embodiment;

FIG. 3 is an exemplary exploded perspective view of the electronic component unit according to the embodiment, viewed from a different angle from that in FIG. 2;

FIG. 4 is an exemplary plan view of the electronic component unit according to the embodiment in a state where a cover and an upper shell are removed;

FIG. 5 is an exemplary cross-sectional view of a section near a rib of the electronic component unit according to the embodiment; and

FIG. 6 is an exemplary perspective view (partial cross-sectional view) of the section near the rib of the electronic component unit according to the embodiment.

### DETAILED DESCRIPTION OF THE PREFERRED EMBODIMENTS

The following describes an embodiment of the invention in detail with reference to the drawings. The invention is not limited by the following embodiment. The components in the following embodiment include those that can be readily substituted by those skilled in the art, or those that are substantially the same components. In the present specification, ordinal numbers are used only to distinguish components, members, portions, locations, directions, etc., and do not indicate order or priority.

### Embodiment

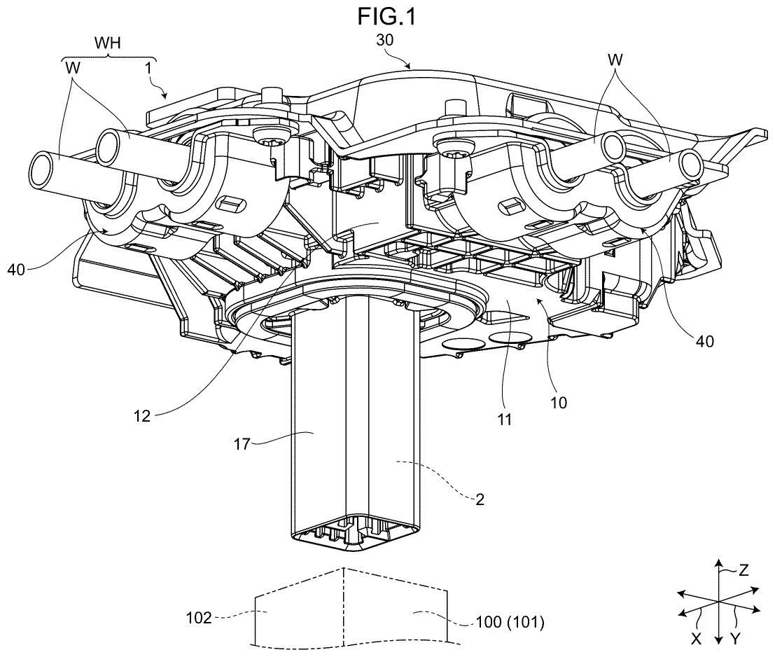

FIG. 1 is a perspective view of a wire harness WH to which an electronic component unit 1 according to the embodiment is applied. The electronic component unit 1 of the embodiment illustrated in FIG. 1 has a connecting portion 17, which mates with a mating portion 101 of a mating connector 100. The electronic component unit 1 is a male connector, into which the tips of a plurality of terminal attached wires W are drawn and which has the connecting portion 17 serving as a coupling portion. The mating connector 100 is a female connector, which has the mating portion 101 serving as the coupling portion. The electronic component unit 1 is built into the wire harness WH that is routed into a vehicle, such as an automobile. In order to achieve electrical connection between devices mounted on a vehicle, for example, the wire harness WH is formed as a component assembly by bundling wiring members used for power supply and signal communication, and the wiring members of the component assembly are connected to each of the devices via the connecting portion 17 or the like. The wire harness WH includes the terminal attached wires W serving as the wiring members, the electronic component unit 1 (connector) provided to the ends of the terminal attached wires W, and the mating connector 100 that is electrically and mechanically coupled to the electronic component unit 1. The wire harness WH may further include various other components such as fixtures, protectors, and grommets.

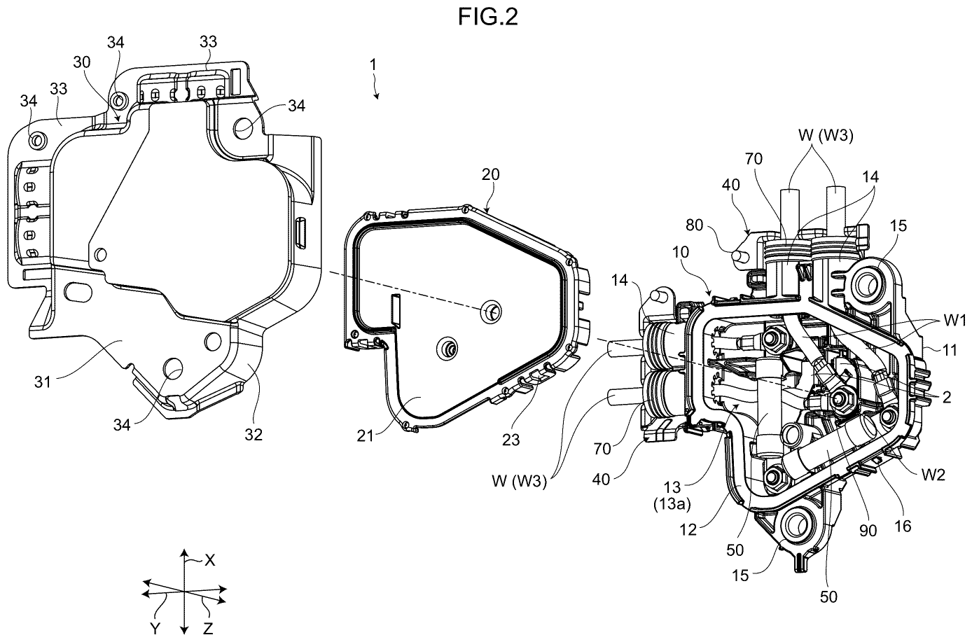

In the following description, among a first direction, a second direction, and a third direction intersecting each other, the first direction is referred to as a “first intersecting direction X,” the second direction is referred to as a “second intersecting direction Y,” and the third direction is referred to as an “assembly direction Z”. The first intersecting direction X, the second intersecting direction Y, and the assembly direction Z are substantially orthogonal to each other. The first intersecting direction X typically corresponds to the front-back direction of the electronic component unit 1, the axial line direction of a pair of two terminal attached wires W (first terminal attached wires), etc. The second intersecting direction Y typically corresponds to the width direction of the electronic component unit 1, the axial line direction of another pair of two terminal attached wires W (second terminal attached wires), etc. The assembly direction Z typically corresponds to the height direction (up-down direction) of the electronic component unit 1, the mating direction (insertion/extraction direction) between the electronic component unit 1 and the mating connector 100, the open direction of a housing space 13 (refer to FIG. 2) of a housing 10, which is described later, the assembly direction (stacking direction) between the housing 10 and a cover 20, etc. Unless otherwise noted, each direction used in the following description is described as the direction in a state where the wire harness WH is assembled in the vehicle.

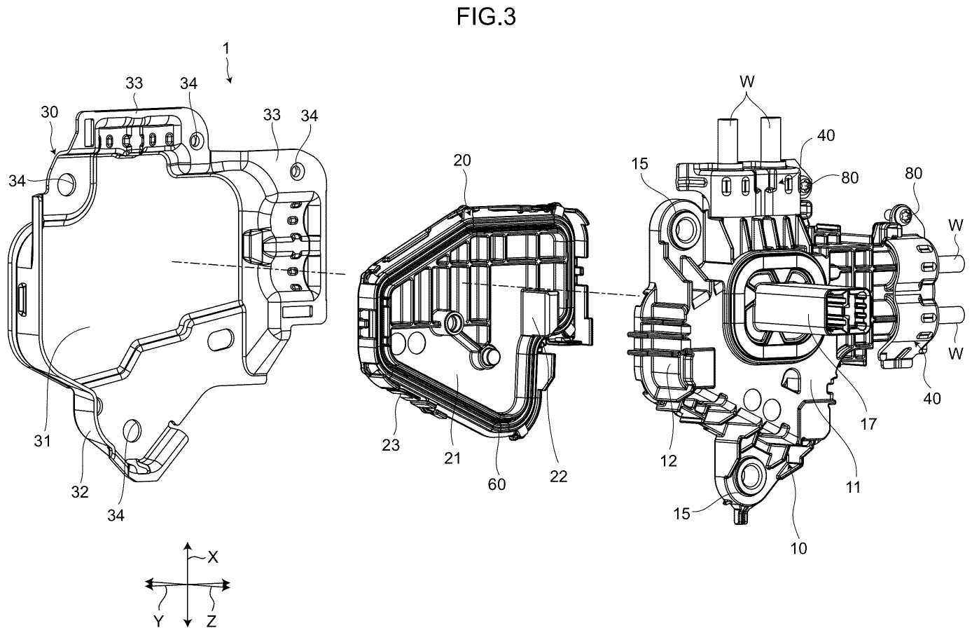

FIG. 2 is an exploded perspective view of the electronic component unit 1. FIG. 3 is an exploded perspective view of the electronic component unit 1, viewed from a different angle from that in FIG. 2. As illustrated in FIGS. 2 and 3, the electronic component unit 1 includes the housing 10, the cover 20, an upper shell 30, lower shells 40, fuses 50, a packing 60, wire packings 70, and fastening members 80. The housing 10 has the housing space 13 that opens on one end side in the assembly direction Z. The housing space 13 houses the tips of the wires W1 in the terminal attached wires W, the fuses 50, etc. In the embodiment, the pair of two terminal attached wires W (first terminal attached wires) are drawn into the housing space 13 along the first intersecting direction X, and the other pair of two terminal attached wires W (second terminal attached wires) are drawn into the housing space 13 along the second intersecting direction Y, in the housing 10.

The terminal attached wire W has a wire W1, a terminal W2 provided at the tip of the wire W1, and an insulating sheath W3 provided around the periphery of the wire W1, for example. The wire W1 includes a linear conductor and an insulating coating that covers the outside of the conductor. The conductor is a core wire consisting of a plurality of conductive metal strands bundled together or a twisted core wire consisting of a plurality of such metal strands twisted together. The insulating coating is a wire coating that covers the outer side of the conductor. The terminal W2, which is a round terminal, for example, is bonded to the core wire exposed at the tip of the wire W1 by means of crimping, laser welding, or other means. The sheath W3, which is an insulating coating that covers the outer side of the wire W1, for example, covers the outer peripheral surface of the portion of the wire W1 that is located outside the housing space 13.

In the embodiment, a shield material, which is not illustrated, is provided between the wire W1 and the sheath W3. The shield material prevents noise from entering the core wire of the wire W1. For example, the shield material may be a braid of metallic wire conductors braided into a mesh and cylindrical shape, or a metallic foil material (what is called metallic foil) formed into a cylindrical shape. The shield material is electrically coupled to a shield terminal, which is not illustrated, for example. The shield terminal is a metal member that is formed in a cylindrical shape. Inside the shield terminal, the wire packing 70 is provided that performs water sealing at the outer peripheral surface of the sheath W3 of the terminal attached wire W and holds the shield terminal to the terminal attached wires W.

The housing 10 is formed of an insulating resin material, for example. The housing 10 includes a bottom wall 11, a peripheral wall 12, wire insertion portions 14, attaching portions 15, an engaging portion 16, and the connecting portion 17. The bottom wall 11 and the peripheral wall 12 are the structural bodies for defining the housing space 13. The housing space 13 is a space portion that houses the tips of the wires W1, the fuses 50, etc., and opens toward the one end side in the assembly direction Z. In the embodiment, the bottom wall 11, the peripheral wall 12, the wire insertion portions 14, the attaching portions 15, and the engaging portion 16 constitute the housing body of housing 10. The connecting portion 17 (refer to FIG. 3) is provided on the outer surface of the bottom wall 11 of the housing body on the opposite side to the housing space 13, and projects from the outer surface toward the other end side in the assembly direction Z. The connecting portion 17 is formed in a rectangular cylindrical shape, for example, and has a plurality of connector terminals 2 inside thereof. The connector terminals 2 are male terminals that are electrically coupled to the female terminal 102 of the mating connector 100 (refer to FIG. 1), for example, and are held inside the connecting portion 17.

The wire insertion portions 14 are provided on the outer surface of the peripheral wall 12 of the housing body on the opposite side to the housing space 13, for example. In the embodiment, the peripheral wall 12 is provided with two of the wire insertion portions 14 aligned along the second intersecting direction Y at one end thereof in the first intersecting direction X, and two of the wire insertion portions 14 aligned along the first intersecting direction X at one end thereof in the second intersecting direction Y. Each wire insertion portion 14 is formed in a substantially cylindrical shape, and communicates with the housing space 13. In other words, the peripheral wall 12 is provided with openings through each of which the internal space of the wire insertion section 14 communicates with the housing space 13. Each terminal attached wire W is inserted into the corresponding wire insertion portion 14, and the tip of the wire W1 is drawn into the housing space 13.

The attaching portion 15 is provided on the outer surface of the peripheral wall 12 of the housing body on the opposite side to the housing space 13, and at a position displaced with respect to the wire insertion portion 14, and projects along the first intersecting direction X, for example. In the embodiment, the peripheral wall 12 is provided with two of the attaching portions 15 at both ends thereof in the first intersecting direction X. Each attaching portion 15 has an insertion hole through which a fastening member such as a bolt is inserted along the assembly direction Z. The housing 10 is fixed to the vehicle by fastening each of the attaching portions 15 together with the upper shell 30 to an attaching portion on the vehicle side with the fastening members, for example.

The engaging portion 16 is provided on the outer surface of the peripheral wall 12 of the housing body on the opposite side to the housing space 13, and at a position displaced with respect to the wire insertion portion 14 and the attaching portion 15, and is formed in a claw shape on the outer surface, for example. In the embodiment, the peripheral wall 12 can be provided with a plurality of the engaging portions 16 spaced from each other. Each of the engaging portions 16 has an engaging surface facing an engaging target portion 23 provided on the cover 20 along the assembly direction Z. The housing 10 is integrated with (fixed to) the cover 20 by engaging each of the engaging portions 16 with the engaging target portion 23 along the assembly direction Z, for example.

The cover 20 is formed of an insulating resin material, for example. The cover 20 includes a cover body 21, a rib 22 (refer to FIG. 3), which is described later, and the engaging target portion 23. The cover body 21 covers the housing space 13 from the one end side in the assembly direction Z in the cover 20. The rib 22 projects from the cover body 21 toward the other end side in the assembly direction Z (in the housing space 13). The engaging target portion 23 is provided on the periphery of the cover body 21 and is engaged with the engaging portion 16 of the housing 10 along the assembly direction Z. The cover body 21 is formed in a substantially flat plate shape that follows the external shape of the peripheral wall 12 of the housing 10, for example. In the embodiment, the packing 60 is provided between the cover 20 and one end surface of the peripheral wall 12 in the assembly direction Z, along the opening edge of the housing space 13.

The packing 60 prevents foreign matter such as moisture from entering the housing space 13 through the gap between the housing 10 and the cover 20. The packing 60 is formed of an elastically deformable member such as rubber or resin, for example. The packing 60 is formed in an annular shape along the opening edge of the housing space 13, for example. The packing 60 is attached in a compressed state between the cover 20 and the peripheral wall 12 of the housing 10 to perform water sealing between the cover 20 and the peripheral wall 12 of the housing 10.

The upper shell 30 is formed of a conductive metallic material in a substantially shell shape, for example. Specifically, the upper shell 30 includes a top plate 31 and a peripheral wall 32 projecting from the peripheral portion of the top plate 31 toward the other end side in the assembly direction Z. The peripheral wall 32 is provided partially intermittently around the top plate 31. Flanged-shaped holding plates 33 are provided to sections on the peripheral wall 32 of the upper shell 30, the sections corresponding to the wire insertion portions 14 of the housing 10. The upper shell 30 thus formed is attached to the housing 10 to cover the cover 20. The upper shell 30 is fastened to the lower shells 40 with the fastening members 80 such as bolts that are inserted into some of a plurality of insertion holes 34 provided to the top plate 31, and fastened to the housing 10 with the fastening members such as bolts that are inserted into the remaining insertion holes 34, for example.

The lower shell 40 is formed of a conductive metallic material in a substantially shell shape, for example. Specifically, the lower shell 40 is formed in a substantially semi-circular cylindrical shape along the wire packing 70 of each of the pair of two terminal attached wires W, for example. The lower shell 40 holds the wire packings 70 and a shield terminal, which is not illustrated, with the holding plate 33 of the upper shell 30. In the embodiment, a plurality of the lower shells 40 are attached to the housing 10, correspondingly to the plurality of pairs of terminal attached wires W.

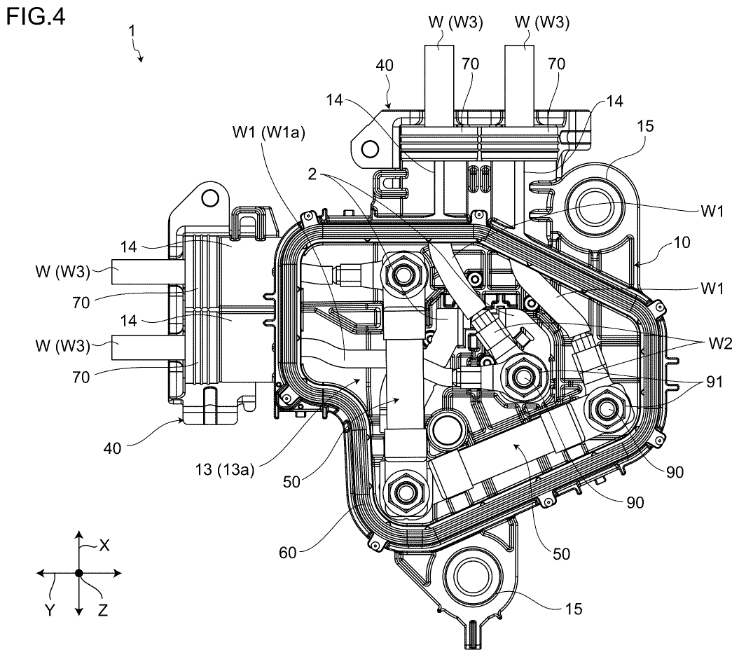

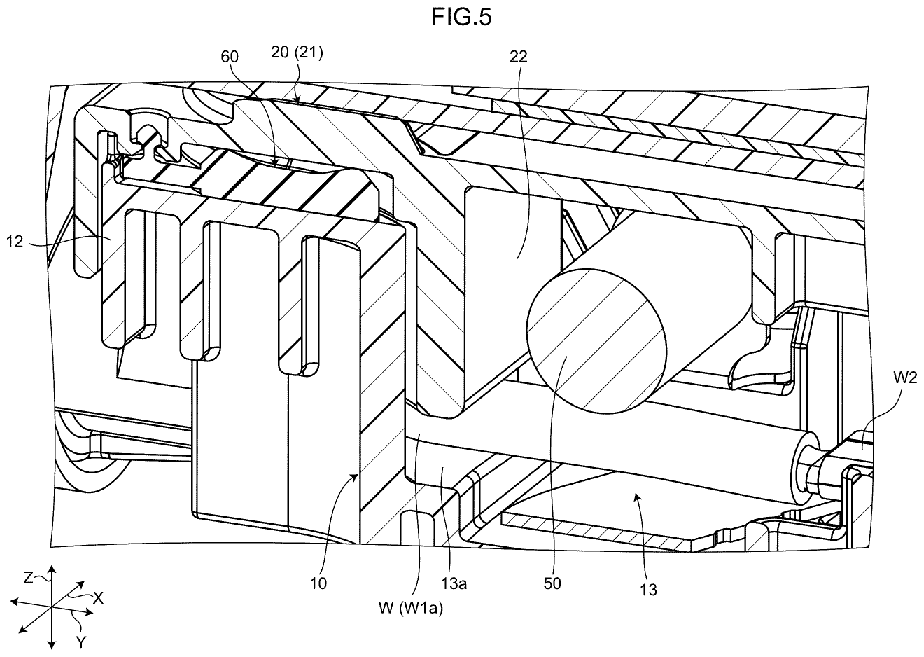

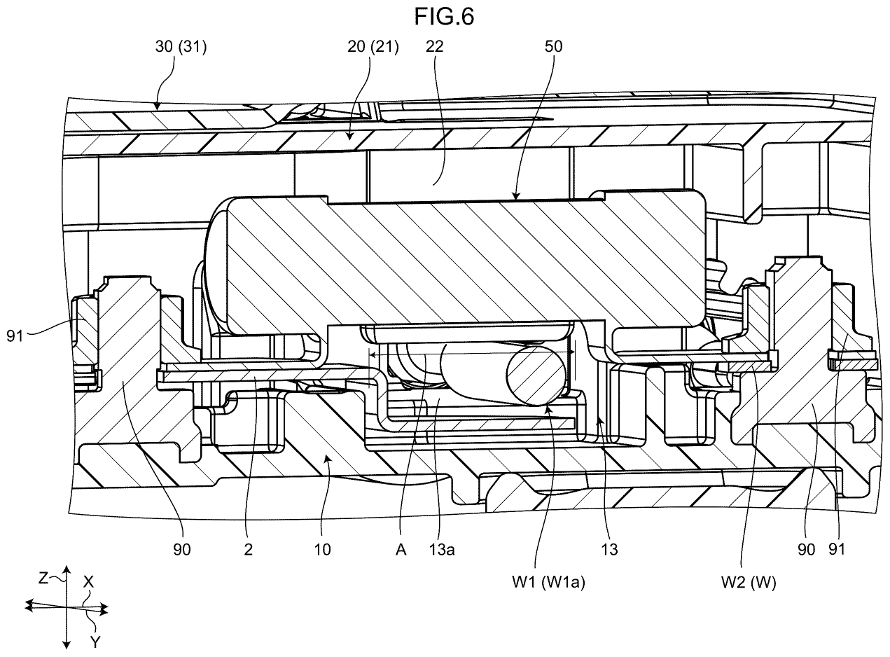

FIG. 4 is a plan view of the electronic component unit 1 in a state where the cover 20 and the upper shell 30 are removed. FIG. 5 is a cross-sectional view of a section near the rib 22 of the electronic component unit 1. FIG. 6 is a perspective view (partial cross-sectional view) of the section near the rib 22 of the electronic component unit 1. As illustrated in FIGS. 4 to 6, the fuse 50 is a circuit protection component that is provided between the connector terminal 2 and the terminal attached wire W, and melts the fusible portion thereof when an overcurrent flows between the connector terminal 2 and the terminal attached wire W, for example. In the embodiment, a plurality of the fuses 50 are provided in the housing space 13. One of the fuses 50 is interposed between one of the connector terminals 2 and one of the pair of two terminal attached wires W (first terminal attached wires) that are drawn into the housing space 13 along the first intersecting direction X. Another one of the fuses 50 is interposed between the one connector terminal 2 and one of the pair of two terminal attached wires W (second terminal attached wires) that are drawn into the housing space 13 along the second intersecting direction Y.

The fuses 50 are housed in the housing space 13 with the wires W1 of the terminal attached wires W. In the embodiment, one of the fuses 50 is disposed in a state where the fuse 50 does not overlap with the wire W1 along the assembly direction Z, while another one is disposed in a state where the fuse 50 overlaps with the wire W1 along the assembly direction Z. Specifically, another one of the fuses 50 is disposed on the one end side of the wire W1 in the assembly direction Z and in a state where the fuse 50 intersects the wire W1. In the embodiment, the wire W1 intersecting the fuse 50 is the wire W1 of the terminal attached wire W that is electrically coupled to the other connector terminal 2. As described above, in the embodiment, the wire W1 is closely provided to the fuse 50, which is in an energized (conducting) state in the housing space 13, such that the wire W1 intersects the fuse 50.

In the embodiment, the cover 20 is provided with the rib 22 (refer to FIGS. 5 and 6) that prevents interference between the wire W1 and the fuse 50. The rib 22 projects from the cover body 21 toward the other end side in the assembly direction Z (toward a bottom 13a side of the housing space 13). The rib 22 presses the wire W1 to the bottom 13a side of the housing space 13 when the cover 20 is fixed to (integrated with) the housing 10 to cover the housing space 13, i.e., when the engaging portion 16 and the engaging target portion 23 engage with each other. As a result, the wire W1 is separated from the fuse 50 on the bottom 13a side of the housing space 13 (the other end side in the assembly direction Z) to prevent the interference between the wire W1 and the fuse 50, thereby preventing any inconvenience caused by the interference between the wire W1 and the fuse 50.

In the embodiment, the wire W1 has an extra length portion W1a that is slack in the housing space 13. The extra length portion W1a ensures the assemblability of the wire W1 to the housing space 13 and absorbs tolerances (manufacturing variations). The extra length portion W1a is a portion that relatively easily interferes with peripheral components such as the fuse 50. In the embodiment, the rib 22 presses the extra length portion W1a to the bottom 13a side of the housing space 13, thereby preventing the interference between the extra length portion W1a and the fuse 50. The length of the rib 22 along the assembly direction Z, i.e., the amount of projection from the cover body 21, is set to a desired length that enables the extra length portion W1a to be pressed to the bottom 13a side of the housing space 13 in a state where the cover 20 is attached to the housing 10 to cover the housing space 13.

The rib 22 is configured such that a width A along the first intersecting direction X (refer to FIG. 6) is larger than the diameter of the wire W1. The width A along the first intersecting direction X of the rib 22 is larger than the diameter of two of the wires W1, for example. In the embodiment, this thus makes it possible for the rib 22 and the wire W1 to be more reliably in contact with each other in a state where the cover 20 is attached to the housing 10 to cover the housing space 13. This, in turn, makes it possible to more reliably prevent the interference between the wire W1 and the fuse 50. The fuse 50 is fastened together with the connector terminal 2 and the terminal W2 of the terminal attached wire W with an insert bolt 90 integrated with the housing 10 and a nut 91, for example.

As described above, the electronic component unit 1 and the wire harness WH of the embodiment include the housing 10, the fuses 50, and the cover 20. The cover 20 has the rib 22 that projects from the cover body 21 toward the other end side in the assembly direction Z and presses the wire W1 to the bottom 13a side of the housing space 13 to prevent the interference between the wire W1 and the fuse 50. This configuration allows the electronic component unit 1 and the wire harness WH to prevent the interference between the wire W1 and the fuse 50 by the rib 22, the interference occurring when vibration is input from the vehicle side to the housing 10 side, for example. As a result, the electronic component unit 1 and the wire harness WH can properly route the wires W1 and the fuses 50 in the housing space 13 of the housing 10, which in turn allows the housing 10 to be downsized by closely arranging the wires W1 and the fuses 50 in the housing space 13.

In the electronic component unit 1 and the wire harness WH of the embodiment, the wire W1 has the extra length portion W1a that is slack in the housing space 13. The rib 22 presses the extra length portion W1a to the bottom 13a side of the housing space 13. This configuration allows the electronic component unit 1 and the wire harness WH to ensure the assemblability of the wire W1 to the housing 10 with the extra length portion W1a, and furthermore to prevent the interference between the wire W1 and the fuse 50 with the rib 22, for example.

In the electronic component unit 1 and the wire harness WH of the embodiment, the rib 22 is configured such that the width A along the first intersecting direction X, which intersects the assembly direction Z, is larger than the diameter of the wire W1. This configuration allows the electronic component unit 1 and the wire harness WH to more reliably prevent the interference between the wire W1 and the fuse 50 with the rib 22, in turn, to prevent inconveniences caused by the interference between the wire W1 and the fuse 50.

The embodiment exemplifies the case in which the electronic component unit 1 is configured as a connector having the connecting portion 17. The electronic component unit 1 is, however, not limited to this example. For example, the electronic component unit 1 may be configured as an electrical junction box having no connecting portion 17, or the like. The embodiment exemplifies the case in which a pair of the fuses 50 are provided in the housing space 13. The number of the fuses 50 is, however, not limited to this example. For example, one or three or more fuses 50 may be provided in the housing space 13. The embodiment exemplifies the case in which the tips of four terminal attached wires W are drawn into the housing space 13. The number of terminal attached wires W is not limited to this example. For example, the tips of two or six or more terminal attached wires W may be drawn into the housing space 13.

The above-exemplified embodiment of the invention is an example. The embodiment is not intended to limit the scope of the invention. The above embodiment can be implemented in various other forms, and various omissions, substitutions, combinations, and modifications can be made without departing from the gist of the invention. Details such as configurations and shapes (structure, type, direction, form, size, length, width, thickness, height, number, arrangement, position, material, etc.) can be modified as needed.

The electronic component unit and the wire harness according to the embodiment have the effect of properly routing the wires and fuses in the housing space of the housing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic component unit, comprising:
a housing that is provided with a housing space that opens on one end side in an assembly direction and into which a tip of a wire is drawn;
a fuse that is housed in the housing space with the wire, and disposed on the one end side in the assembly direction of the wire in a state where the fuse intersects the wire; and
a cover that has a cover body covering the housing space from the one end side in the assembly direction, and a rib projecting from the cover body toward the other end side in the assembly direction and pressing the wire to a bottom side of the housing space to prevent an interference between the wire and the fuse.

2. The electronic component unit according to claim 1, wherein
the wire has an extra length portion that is slack in the housing space, and
the rib presses the extra length portion to the bottom side of the housing space.

3. The electronic component unit according to claim 1, wherein
the rib is configured such that a width along a first intersecting direction that intersects the assembly direction is larger than a diameter of the wire.

4. The electronic component unit according to claim 2, wherein
the rib is configured such that a width along a first intersecting direction that intersects the assembly direction is larger than a diameter of the wire.

5. A wire harness, comprising:
a conductive wire; and
an electronic component unit that is provided at an end of the wire, wherein
the electronic component unit has:
a housing that is provided with a housing space that opens on one end side in an assembly direction and into which a tip of the wire is drawn;
a fuse that is housed in the housing space with the wire, and disposed on the one end side in the assembly direction of the wire in a state where the fuse intersects the wire; and
a cover that has a cover body covering the housing space from the one end side in the assembly direction, and a rib projecting from the cover body toward the other end side in the assembly direction and pressing the wire to a bottom side of the housing space to prevent an interference between the wire and the fuse.
